(19) United States
(12) Patent Application Publication
(10) Pub. No.: US 2006/0165965 A1
(43) Pub. Date: Jul. 27, 2006

(54) Polymeric films and packages produced therefrom

(76) Inventor: Robert James Massey, Bristol (GB)

Correspondence Address: BACON & THOMAS, PLLC, 625 SLATERS LANE, FOURTH FLOOR, ALEXANDRIA, VA, 22314, US

(21) Appl. No.: 10/547,523

(22) PCT Filed: Mar. 1, 2004
(86) PCT No.: PCT/GB04/00812

§ 371 Date: Aug. 31, 2005

(30) Foreign Application Priority Data
Mar. 1, 2003 (GB) 0304757.8

(51) Int. Cl. B32B 7/02

(52) U.S. Cl. 428/212

(57) ABSTRACT

Thermoplastic polymeric films having at least two olefin based polymer layers each including a major amount of an olefin based polymer, at least one of said layers containing a high molecular weight siloxane polymer having a viscosity of greater than 1.5×10⁴ N.s.m², and the layer or layers containing the high molecular weight siloxane polymer having a combined thickness of greater than 10 pm. Such films when thermoformed have shown good transit resistance when used for packaging articles.

This invention concerns polymeric films for use as packaging materials, particularly for transporting articles therein, and packages produced from such films.

Resistance to damage in transit is a valuable property for polymeric films used for packaging, and especially when maintaining packaged articles in sterile environments, for example sterilised medical equipment, where sterility can be compromised by pinholing.

According to the present invention there are provided thermoplastic polymeric films comprising at least two olefin based polymer layers each comprising a major amount of an olefin based polymer, at least one of said layers containing a high molecular weight siloxane polymer having a viscosity of greater than 1.5×10⁴ N.s.m⁻², and the layer or layers containing the high molecular weight siloxane polymer having a combined thickness of greater than 10 μm.

The high molecular weight siloxane polymer is preferably substantially not cross-linked, and it is preferably non-migratory at room temperature. Preferred high molecular weight siloxane polymers for use in the present invention include polydimethylsiloxanes. Particularly preferred high molecular weight siloxane polymers for use in accordance with the present invention are sold in the form of masterbatches dispersed in polypropylene homopolymers under the trade names MB50-001 (Dow Corning) and Polybatch T9535 (A Schulman Inc. Ltd), dispersed in low density polyethylene under the trade name MB50-002 (Dow Corning), and dispersed in linear low density polyethylene under the trade name MB50-313 (Dow Corning).

The high molecular weight siloxane polymer should be present in an amount sufficient to reduce transit damage of packages made from the films. In general the amount of siloxane polymer will be not more than 5 wt % of the layer or layers in which it is present, and preferably not more than 4 wt %. However, it is preferably present in an amount of at least 0.5 wt %, and more preferably at least 1 wt %, of the layer or layers in which it is present.

Films in accordance with the present invention can have a single layer containing a high molecular weight siloxane polymer, but the siloxane polymer can be present in one or more further polymeric layers.

The olefin based polymer layers of films of the present invention are preferably derived from one or more of ethylene and alpha-olefins, for example propylene or butylene-1, and optionally including a minor amount of units derived from one or more ethylenically unsaturated monomers, for example ethylenically unsaturated aliphatic acids or esters, e.g. vinyl acetate, methacrylic acid or acrylic acid. Examples of polymers for forming these layers include aliphatic homopolymers and copolymers, for example, polyethylenes, e.g. HDPE, MDPE, LDPE and LLDPE, polypropylene, and copolymers of two or more of ethylene, propylene and butylene-1.

At least one of the outer layers of films of the present invention is preferably derived from an ethylene based polymer, and more particularly containing at least 50% by weight of an ethylene homopolymer or an ethylene copolymer containing a major proportion of units derived from ethylene. When ethylene copolymers are used, they can contain units derived from one or more other aliphatic olefins, and optionally minor amounts of one or more other ethylenically unsaturated monomers, for example ethylenically unsaturated aliphatic acids or esters, e.g. vinyl acetate, methacrylic acid or acrylic acid. Outer layers derived from, and more particularly containing at least 50% by weight of ethylene homopolymers and ethylene copolymers can provide films of the present invention with heat sealabililty.

Films of the present invention include at least two olefin derived polymeric layers, and they can be two, three, four, five or more layered films, the layers being formed from the same or different olefin derived polymers from those of the other layers. For example, where two of the olefin derived polymers of different layers do not form strong bonds between each other, intermediate layers between such olefin derived polymers can perform the function of tie layers, for example using olefin derived polymers containing units derived from one or more ethylenically unsaturated aliphatic acids or esters.

In general, increasing the thickness of the layer or layers of films of the present invention which contain a high molecular weight silioxane increases the transit resistance of the films. The thickness of the layer or the combined thickness of the layers containing the high molecular weight silioxane should be greater than 10 μm, preferably at least 12 μm, and more preferably at least 20 μm. Greater combined thicknesses can be used, for example of 40 μm or more, and even up to 300 μm , but the improvement in transit resistance as a result of adding the high molecular weight silioxane will in general be balanced against the cost of the additional amount of high molecular weight silioxane.

The total thickness of the layer or layers containing the high molecular weight silioxane is preferably not more than 60% of the total thickness of the films.

It is generally preferred that at least one layer of films of the present invention is substantially devoid of a high molecular weight silioxane.

A high molecular weight silioxane can be present in one or more of the layers of films of the present invention. In general it is preferred that at least one of the outer layers of the films contains a high molecular weight silioxane, which will necessarily be the case with two layered films. However, where three or more layers are present it is generally preferred that at least one layer, and preferably two outer layers, of the films contains a high molecular weight silioxane. The other layers can be substantially devoid of the high molecular weight silioxane, or one or more of these other layers can contain a high molecular weight silioxane.

Films in accordance with the present invention can be of a variety of thicknesses, for example depending on the number of layers which are present and the particular end use to be made of them. Films of the present invention will in general be greater than 20 μm thick, but they can be much thicker, for example 400 μm thick or more. A preferred range of thicknesses is from 40 to 300 μm .

Surprisingly polymeric films in accordance with the present invention have exhibited good performance in transit testing even if the layer containing the high molecular weight siloxane polymer does not form an outer surface of the film. Thus the high molecular weight siloxane can be in one or more layers of films of the present invention and not necessarily in an outer layer. However, if desired, both outer layers can contain a high molecular weight siloxane polymer.

When only one of the outer layers of films of the present invention contains a high molecular weight siloxane, it is preferably the layer which is used to form an external surface of packages produced from the films.

A preferred film structure consists of one outer polyolefin layer containing a high molecular weight siloxane and forming from 5 to 50%, preferably from 10 to 40%, of the total thickness of the film, with the remainder of the film consisting of one or more polyolefin layers which are substantially devoid of a high molecular weight siloxane.

Another preferred film structure consists of one outer polyolefin layer and one inner polyolefin layer, both containing a high molecular weight siloxane, and one or more further layers which are substantially devoid of a high molecular weight siloxane, the combined thicknesses of the layers containing a high molecular weight siloxane preferably representing not more than 60% of the thickness of the film.

Films in accordance with the present invention are preferably heat sealable. It has surprisingly been found that when heat sealable polyolefins are used, the heat sealability of the polyolefins remains substantially unchanged when they contain high molecular weight siloxanes at the preferred levels indicated above for reducing transit damage to packs made from the films. If the polyolefin is not heat sealable, heat sealability can be imparted to the films by applying a heat sealable coatings to them. Such coating materials are well known in the polyolefin film art.

Heat sealable layers of films of the present invention are preferably formed from olefin based polymers including units derived from two or more of ethylene, propylene, butylene-1, and octene-1, and optionally containing a minor amount of units derived from one or more ethylenically unsaturated monomers, for example ethylenically unsaturated aliphatic acids or esters, e.g. vinyl acetate, methacrylic acid or acrylic acid.

Films of the present invention can include additives used in the polymeric film art, for example slip, anti-block and/or anti-static agents.

Films in accordance with the present invention can be prepared by known methods, for example they can be prepared by casting melts of the appropriate polymers for the desired layers or by the so-called bubble process using melts of the appropriate polymers. When the so-called bubble process is used the blow up ratio in the machine and transverse directions is preferably at least 1.1:1, and it can be as much as 2.5:1 or more, a particularly preferred range of ratios being from 1.5:1 to 2.5:1.

The present invention also provides packages made from films of the present invention, a film of the present invention then forming at least part of the outer surface of the packages.

Packages in accordance with the present invention can take a variety of shapes and forms which will usually depend on the article or articles to be packaged. For example they can be hot or cold sealed around an article or articles to be packaged or they can be sealed to another web with the article or articles to be packaged therebetweeen to form bags or pouches. Films in accordance with the present invention can also be thermoformed to receive articles to be packaged, and then closed using a top web which can be hot or cold sealed to the thermoformed film.

The following Examples are given by way of illustration only.

### EXAMPLES 1-3

Three four layered films were cast from melts of a first layer of polypropylene homopolymer, a second layer of an adhesive tie layer formed from a blend of polyolefin elastomers, a third layer of low density polyethylene, and a fourth layer of linear low density polyethylene containing units derived from octene-1. The first layer of each film contained 0.2 wt % of erucamide based on the weight of the layer and added as 4 wt % of a masterbatch in polyethylene to the polypropylene, and the fourth layer of each film contained 0.1 wt % of erucamide based on the weight of the layer and added as 2 wt % of a masterbatch in polyethylene added to the LLDPE, the erucamide being added in each case as a slip agent.

The melts were cast on to a chill roll at 40° C. using an air knife, the fourth layer contacting the chill roll. The films were then wound up.

The first layer each film was 35 μm thick, the second layers each being 10 μm thick, the third layers being 35 μm thick, and the fourth layers being 20 μm thick.

The three films respectively either contained no high molecular weight polysiloxane (Example 1) or 3 wt % of a high molecular weight polysiloxane with a viscosity of greater than 1.5×10⁴ N.s.m⁻², added as a 50% by weight masterbatch in polypropylene homopolymer as a masterbatch carrier (Schulman Polybatch T9535) to one or more of the four film layers. One film contained the high molecular weight polysiloxane in the third layer formed from low density polyethylene (Example 2), and the remaining film (Example 3) contained the high molecular weight polysiloxane in both the first (polypropylene) and fourth (LLDPE) layers.

Samples of each of these three films were then subjected to a simulated transit test which was carried out in five stages as follow.

Polypropylene syringes (Becton Dickinson Plastipack (Trade Mark) 10 ml eccentric Luer-slip) were packaged in each of the films to be tested using a Multivac R7000 packaging machine which involves thermoforming the film into an appropriate die, loading the syringes on to the film by hand, and then heat sealing a top web on to the fourth layer of the thermoformed film. The top web in each case was a three layered structure consisting of a 44 g/m² bleached kraft paper, a 29 g/m² low density polyethylene layer, and a 4 g/m² layer of a peelable lacquer which adhered the top web to the thermoformed film.

Individual syringe packs were then cut by hand from the thermoformed web produced by the packaging machine, and a single pin-hole was made in each pack through the top web (paper/polyethylene/lacquer web). These packages were then packed in corrugated cardboard boxes so that each box contained 100 syringes, and five such boxes were prepared for each evaluation. The boxes used were those normally used by Becton Dickinson to pack Plastipack 10 ml eccentric Luer-slip syringes, being 17 cm×19 cm×29 cm, and the syringe packs were arranged in the boxes in the same manner as is normally used by Becton Dickinson to pack Plastipack 10 ml eccentric Luer-slip syringes. The boxes were then closed, and their lids were held in place with pressure sensitive adhesive tape.

The boxes of packaged syringes were then subjected to a simulated transit test which consisted of a drop test using equipment complying with ASTM D-744 Gaynes Test Model #104, followed by a drop test using equipment complying with ASTM D-999 Method A Gaynes Table and then a further drop test.

The first drop test consisted of dropping the boxes from a height of 38.1 cm on to a flat surface, firstly on to the bottom surface of the boxes, then on to one long edge of the bottom surface of the boxes, followed by dropping them on to one of the shorter edges of the bottom surface of the boxes. Thereafter they were dropped on to the bottom corner of the boxes at one end of the long edge on which they had already been dropped which was not shared by the short edge on which they had been dropped, then on the diagonally opposite corner of the bottom of the boxes, and finally on the top surface of the boxes.

The vibration test was then carried out by placing the boxes on the vibration table in the orientation in which they would normally be shipped. During the test the boxes were restrained sufficiently to prevent them moving off the table whilst permitting free movement in any horizontal direction.

The table was then vibrated at a frequency of 217 cycles per minute to produce an acceleration of 1 G or a speed sufficient to cause the boxes to leave the table momentarily so that a shim can be inserted between the bottom of the boxes and the surface of the table. The shim should also be capable of being intermittently moved along one entire edge of the longest dimension of the boxes.

Vibration of the boxes was continued for a total of one hour, a single rotation of the boxes through 90° after the first half hour.

Finally, the boxes were dropped on to a flat surface from a height of 76.2 cm on to their bottom surfaces.

Following the simulated transit test, all of the syringe packs were inspected for failures in the form of holes in the packs. This was carried out by sealing the pin holes made in the packs prior to being placed in the transit boxes using pressure sensitive adhesive tape. These packs were then placed five at a time in a vacuum dessicator, the lid was placed on the dessicator, and the dessicator was then evacuated using a vacuum pump. The air pressure in the dessicator was reduced to 1260 Pa and maintained at this value for 30 seconds.

Syringe packs which had not developed holes during the test inflated to a size which remained constant over the 30 second period, whereas those which had been holed either failed to inflate or failed to hold a constant level of inflation over the 30 second period.

All of the packs that failed were inspected individually to identify the position of the hole that caused their failure, and the number of packs that failed due to hole formation in the three polymeric films was then calculated as a percentage of the total test sample.

The following percentage failures were obtained for the three films tested.

| | Example | | |
|---|---|---|---|
| | 1 (comparison) | 2 | 3 |
| Film Failures (%) | 9.4 | 4.4 | 2.4 |

The films in accordance with the present invention (Examples 2 and 3) showed substantially lower failure rates than a substantially similar film without the presence of the high molecular weight siloxane polymer having a viscosity of greater than 1.5×10⁴ N.s.m⁻².

### EXAMPLES 4-6

Three films were produced as described for Examples 1-3 except that the erucamide masterbatch was omitted from the respective first layers but included in the respective fourth layers. The film of Example 4 therefore contained none of the high molecular weight siloxane polymer, that of Example 5 contained 3 wt % of the high molecular weight siloxane polymer added as Polybatch T9535 in the fourth, LLDPE, layer, and that of Example 6 contained 3 wt % of the high molecular weight siloxane polymer added as Polybatch T9535 in the third, LDPE, layer.

These films were each thermoformed as described for Examples 1 to 3, syringes were inserted into the thermoformed films, and the same sealing web was heat sealed to the fourth layer of the fourth thermoformed films.

The packaged syringes were boxed as described in Examples 1 to 3, and the boxes were subjected to a simulated transit test as described for Examples 1-3. The percentage failures observed with these three films are given below.

| | Example | | |
|---|---|---|---|
| | 4 (comparison) | 5 | 6 |
| Film Failures (%) | 8.0 | 7.0 | 3.8 |

The films in accordance with the present invention (Examples 5 and 6) showed substantially lower failure rates than a substantially similar film without the presence of the high molecular weight siloxane polymer having a viscosity of greater than 1.5×10⁴ N.s.m⁻².

### EXAMPLES 7 and 8

Two three layered films were prepared substantially as described for Examples 1-3 by casting melts of a first layer consisting of an ethylene/propylene random copolymer containing erucamide as a slip agent and a particulate anti-block agent, a second layer formed from a blend of 50% by weight of the copolymer used for the first layer with 50% by weight of an ethylene/propylene elastomer, a third layer of a blend of 70% by weight of a polyolefin elastomer and 30% by weight of LLDPE containing units derived from octene-1, and a fourth layer consisting of a blend of 98.5% by weight of LLDPE containing units derived from octene-1 and 1.5% by weight of a masterbatch of erucamide and an antiblock agent in polyethylene so that the fourth layer contained 0.075% by weight of erucamide.

The first layer of one of the films (Example 8) contained 6% by weight of a masterbatch formed from 50% by weight of a blend of a high molecular weight polysiloxane with a viscosity of greater than 1.5×10⁴ N.s.m⁻² and 50% by weight of polyethylene as a carrier, in addition to the ethylene/propylene copolymer, and the other film (Example 7) did not contain any of the masterbatch.

Each film was cast on to a chill roll at 25° C. using an air knife, layer 4 of each film contacting the roll.

The overall thicknesses of these films was 80 μm , the first layer in each case being 15 μm thick, the second in each case being 45 μm thick, the third in each case being 10 μm thick, and the fourth in each case also being 10 μm thick.

These films were then used to package syringes and were subjected to transit testing substantially as described for Examples 1-3 except that since these films were expected to have a higher transit resistance than those of Examples 1-3, more packs of syringes were subjected to the test in order to increase the number of failures overall and thereby provide a greater confidence in the results. 1000 syringe packs were therefore used to test the film of Example 7, and 1500 syringe packs were used to test the film of Example 8.

The following percentage failures were obtained from the two films.

Example

| | 7 (comparison) | 8 |
|---|---|---|
| Film Failures (%) | 4.0 | 2.8 |

From these Examples, the addition of the high molecular weight silicone to the first outer layer (Example 8) has reduced the failure rate by 30% compared with the comparison film (Example 7).

This compares with results for Examples 1 and 2 above, where the layer containing the high molecular weight siloxane was 35 μm thick and resulted in a decrease in the failure rate of 53%.

### EXAMPLE 9

A film was produced substantially as described for Example 8, except that the layer thicknesses were changed, the film itself being 80 μm as in Example 8.

The first layer of this film was 28 μm thick, the second layer was 42 μm thick, the third layer was 5 μm thick, and the fourth layer was 5 μm thick.

500 syringes were packaged in this film as described for Examples 1-3, and they were subjected to transit testing as described for Examples 1-3.

The percentage of film failures in this case was 0.6%, representing an 85% reduction in the failure rate compared with the film of Example 7 which contained no high molecular weight siloxane.

The above Examples show that when a high molecular weight siloxane is present at a particular percentage loading in a layer of polyolefin films containing the siloxane, the transit resistance of the films increases when the thickness of the layer containing the high molecular weight silicone is increased.

1. A thermoplastic polymeric film comprising at least two olefin based polymer layers each comprising a major amount of an olefin based polymer, at least one of said layers containing a high molecular weight siloxane polymer having a viscosity of greater than 1.5×10⁴ N.s.m⁻², and the layer or layers containing the high molecular weight siloxane polymer having a combined thickness of greater than 10 μm .

2. A film according to claim 1, wherein the layer or layers containing the high molecular weight siloxane polymer have a combined thickness of greater than 12 μm .

3. A film according to claim 1, wherein the layer or layers containing the high molecular weight siloxane polymer have a combined thickness of greater than 15 μm .

4. A film according to claim 1, wherein the layer or layers containing the high molecular weight siloxane polymer have a combined thickness of greater than 20 μm .

5. A film according to claim 1, wherein the layer or layers containing the high molecular weight siloxane polymer each contain not more than 5 wt % thereof.

6. A film according to claim 1, wherein the layer or layers containing the high molecular weight siloxane polymer each contain at least 0.5 wt % thereof.

7. A film according to claim 1, wherein the film has at least one of the outer layers containing the high molecular weight siloxane polymer.

8. A film according to claim 1, wherein at least one of the outer layers of films of the present invention comprises a major amount of an ethylene based polymer.

9. A film according to claim 8, wherein the ethylene based polymer comprises at least 50% by weight of an ethylene homopolymer or an ethylene copolymer containing a major proportion of units derived from ethylene.

10. A film according to claim 1, wherein the layer or layers containing the high molecular weight siloxane polymer form not more than 60% of the total thickness of the film.

11. (canceled)

12. A package comprising at least one film according to claim 1 sealed around at least one packaged article.

13. A package according to claim 12, wherein the film is sealed to itself around the least one packaged article.

14. A package according to claim 12, wherein the film is sealed to a sealing web.

15. A package according to claim 12, wherein an outer surface of the package formed by the film forms an outer surface of the package.

16. A package according to claim 12, wherein the said film has been thermoformed.
